(19) United States
(12) Patent Application Publication
(10) Pub. No.: US 2021/0126871 A1
(43) Pub. Date: Apr. 29, 2021

(54) OUTLIER EVENT AUTOSCALING IN A CLOUD COMPUTING SYSTEM

(71) Applicant: Red Hat, Inc., Raleigh, NC (US)

(72) Inventor: Alissa Bonas, Kiryat Bialik (IL)

(21) Appl. No.: 16/663,667

(22) Filed: Oct. 25, 2019

(51) Int. Cl. H04L 12/911; H04L 29/08

(52) U.S. Cl. CPC H04L 47/746; H04L 67/28; H04L 47/82; H04L 67/10

(57) ABSTRACT

Certain features and aspects provide an autoscaler that includes automatic detection of events that suggest malfunctioning resources being used by an instance of an application. Such events can be referred to as outlier events because they are generated based on resource utilization metrics for an instance of an application, such as a pod, being statistically outlying relative to what is typical for resources being used by current instances of the application. In some examples, a network proxy ejects misbehaving instances (pods) from the pool of instances that receive traffic, and these ejection events are monitored by the autoscaler. Aspects and features thus combine the handling of an event that causes an instance to temporarily not receive traffic with the scaling of instances for usage demands by the autoscaler.

### TECHNICAL FIELD

The present disclosure relates generally to managing resources for instances of an application running in a cloud network. More specifically, but not by way of limitation, this disclosure relates to determining an appropriate number of instances of the application based on both usage demands and hardware or software errors unrelated to usage.

### BACKGROUND

A cloud computing system such as one based on Kubernetes®, OpenShift®, or another container orchestration platform includes clusters to which various applications are deployed. Some applications are designed to be replicated so that multiple instances of the application run simultaneously in the cloud system and share the load of user requests. Such an application is sometimes referred to as a microservice and one of its instances is sometimes referred to as a pod. Requests are routed to the pods, for example, requests to make use of a service provided by the application or to obtain or display information generated by the application.

Network clusters often have access to limited costly resources such as processing power, memory and storage space. In order to handle workloads efficiently and cost-effectively when the system is used to run many pods, resources are provisioned according to demand. Since demand for a cloud-based application (and therefore its resources) is dynamic and can vary dramatically over time, management of pod-based cloud computing systems typically involves autoscaling the number of pods running at any given time. Autoscaling can be used to automatically increase the number of pods used for an application when demand increases and decrease the number of pods used for the application when demand decreases.

### BRIEF DESCRIPTION OF THE DRAWINGS

FIG. 1 is a block diagram of an example of a system that includes an autoscaler that takes outlier events into account according to some aspects of the disclosure.

FIG. 2 is a block diagram of an example of a system that includes program code and stored values related to autoscaling based on outlier events according to some aspects of the disclosure.

FIG. 3 is a flowchart of an example of a process for providing autoscaling based on outlier events according to some aspects of the disclosure.

FIG. 4 is a flowchart of another example of a process for providing autoscaling based on outlier events according to some aspects of the disclosure.

### DETAILED DESCRIPTION

A container orchestration platform often has a component referred to as a horizontal autoscaler (horizontal automatic scaler). This component autoscales (automatically scales) the number of pods (instances) assigned to an application up or down based on predefined usage metric values and a desired numerical range for each value, typically provided by the administrator of the system. The horizontal autoscaler operates under the assumption that all known pods are fully functional. Problems such as hardware failures or operating system bugs that adversely impact performance are dealt with independently of autoscaling.

Autoscaling of application instances is typically carried out based on a metric that is related to the application's performance relative to usage demands, such as CPU utilization or another custom metric. In microservice environments where a service mesh exists and a network proxy controls the communication between microservices, the network proxy controls whether a microservice instance is receiving traffic or shall temporarily not receive traffic. This decisioning is independent of and has no effect on the autoscaling of the microservice for current usage levels, but still adversely impacts performance as experienced by the end user because the autoscaler allocates pods that may not be able to receive traffic.

Some examples of the present disclosure overcome one or more of the issues mentioned above by providing an autoscaler that includes automatic detection of events that suggest malfunctioning resources assigned to an instance of an application. Such events can be referred to as outlier events because they are generated based on error metrics for hardware or software resources being statistically outlying relative to what is typical for those generally dedicated to running current instances of the application. Such error metrics may include, as an example, the frequency with which a certain error occurs or the existence of a particular type of error.

In some examples, a network proxy ejects misbehaving instances (pods) from the pool of instances that receive traffic based on an event corresponding to a resource failure. A misbehaving instance can also rejoin the pool under some circumstances. These ejection and insertion events are monitored by the autoscaler so that resources compromised by malfunctions or errors are taken into account as part of the autoscaling process. Aspects and features thus combine the logic of an event that causes an instance or replica to temporarily not receive traffic, into the process that scales instances based on usage. An event that causes an instance to stop receiving traffic will also act as a trigger to autoscale up so that a new instance is available to receive the traffic, thus improving performance and throughput experienced by end users.

As an example, a processing device in a system can access a resource utilization metric for an application running in a cloud system. The processing device can determine an autoscale value for a number of instances of the application running in the cloud system in order to maintain a target value for the metric. The processing device can detect an outlier event corresponding to a resource failure for an instance of the application. The autoscaled value for the number of instances of the application running in the cloud system can then be adjusted to account for the outlier event.

In some examples, the value of the metric is maintained by keeping the resource utilization metric within a preselected range of the target value of the metric. In some examples the outlier event can include an ejection or an insertion of an instance of the application, where ejection occurs when a resource failure is detected. As examples, a failure rate, a number of consecutive failures, or percentage of failed operations of the instance of an application can trigger an ejection.

In some examples, a resource controller deploys instances of the application organized in a service mesh and can scale the number of instances. In some examples, a horizontal autoscaler can determine autoscaled values and provides these values to the resource controller. In some examples, a network proxy initiates outlier events, such as ejections. The horizontal autoscaler can monitor the network proxy to determine when an outlier event, such as an ejection, has occurred.

These illustrative examples are given to introduce the reader to the general subject matter discussed here and are not intended to limit the scope of the disclosed concepts. The following sections describe various additional features and examples with reference to the drawings. The drawings, like the illustrative examples, should not be used to limit the present disclosure.

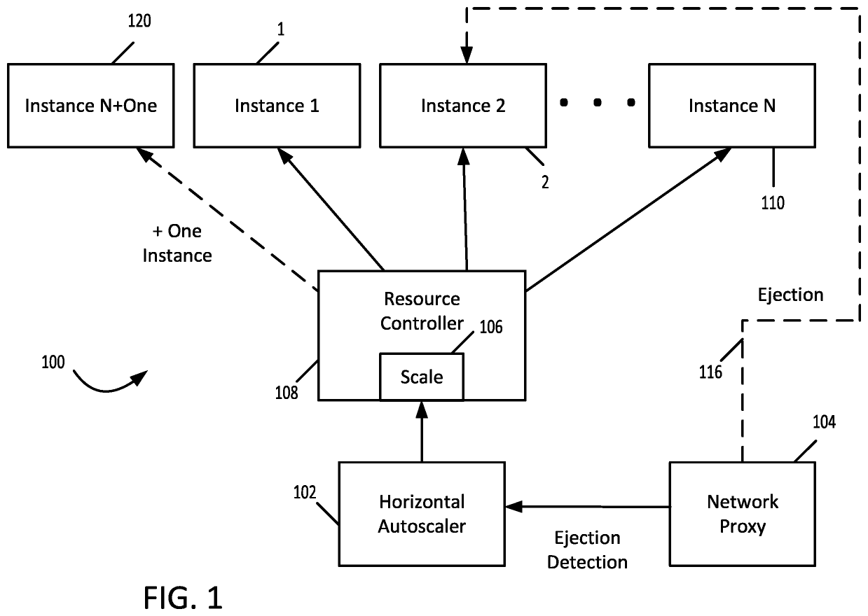

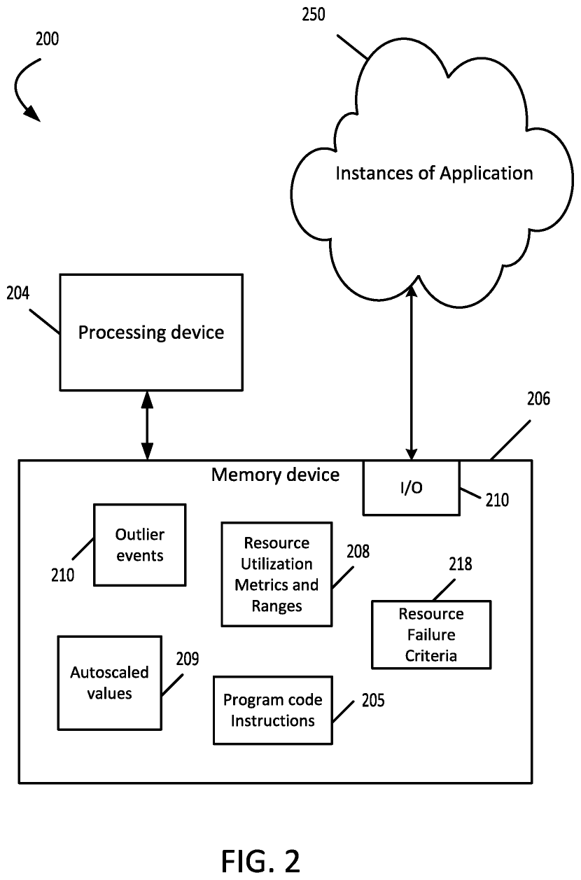

FIG. 1 is a block diagram of an example of a system 100 that includes an autoscaler that takes outlier events into account according to some aspects of the disclosure. More specifically, the system 100 illustrates the software entities and their communication paths for an example of such a system. A computing device can execute software as defined below with respect to FIG. 2, which causes the computing device to perform the tasks of, as examples, the horizontal autoscaler 102 or the network proxy 104. In this particular example, horizontal autoscaler 102 provides input to a scale function 106 within a resource controller 108. Resource controller 108 provisions an appropriate number of instances for a containerized application running in the cloud system and applies scale function 106 to scale (adjust or set) the number of instances being used for the application in accordance with an autoscaled value. Initially in this example, resource controller 108 has provisioned N instances. The initially provisioned instances include instance 1, instance 2, and instance N (110).

Still referring to FIG. 1, network proxy 104 has detected a resource failure in instance 2. Network proxy 104 ejects instance 2 and sends a notification 116 to instance 2, creating an ejection event and causing instance 2 to be removed from the pool of instances of the application that can receive traffic. Horizontal autoscaler 102 is listening for outlier events, and detects the ejection. Horizontal autoscaler 102 then notifies resource controller 108 to increase the autoscaled value for the number of instances allocated to the current application by one instance. Thus, a new instance 120, instance N+1, is added to the pool. It should be noted that multiple ejection (or insertion) events may be detected during a listening window, so that multiple instances can be added or subtracted from the pool of instances at approximately the same time. As an alternative to having the horizontal autoscaler 102 listening for outlier events, the autoscaler 102 could instead periodically check for the ejection status of instances using query-response messaging, and take that number of instances into account when making autoscaling calculations.

A system like that shown and described above with respect to FIG. 1 can be implemented in almost any container orchestration platform architecture. Container orchestration platforms such as those based on Kubernetes or OpenShift are examples of cloud computing systems on which aspects and features of this disclosure may be implemented. With such platforms, an instance may be referred to as a pod and the autoscaler may be referred to as a horizontal pod autoscaler. A microservice is an example of a containerized application that may run in such a system. As an illustrative example of an implementation within such a system, where a service mesh (e.g., Istio®, Envoy network proxy) is added to manage the microservice communication, the network proxy (e.g., Envoy) includes a process to eject misbehaving instances (pods) from the pool of instances that receive traffic. This ejection can be based on various resource failure criteria selected by an administrator. For example, a pod that has three consecutive http-500 errors will not receive traffic, or will be ejected from the pool of pods for a specified amount of time, for example, ten minutes, after which, the pod is inserted back into the pool to receive traffic. The pod will still be up and running during that time, hence it would be treated as available by a horizontal pod autoscaler that does not employ aspects and features of this disclosure unless other performance metrics such as CPU utilization reflect the http-500 errors. If the autoscaler does not take the ejection into consideration, and the proxy, as an example, ejected two pods out of five for such errors, all five pods are up and would be treated as available by the autoscaler, but only three are actually handling traffic and those three pods would likely become overloaded, resulting in a performance degradation. Aspects and features of this disclosure add to or change the autoscaler to consider outlier detection ejection events.

FIG. 2 is a block diagram of an example of a system that includes program code and stored values to enable autoscaling based on outlier events according to some aspects of the disclosure. The system 200 includes the processing device 204 that can execute computer program code, also referred to as software, instructions, or program code instructions 205, for performing operations related to providing autoscaling that includes consideration for outlier events according to some aspects of the disclosure. Processing device 204 is communicatively coupled to the memory device 206. The processing device 204 can include one processing device or multiple processing devices. Non-limiting examples of the processing device 204 include a field-programmable gate array (FPGA), an application-specific integrated circuit (ASIC), a microprocessor, etc. Software can include computer-readable instructions that are executable by a processing device 204, such as program code instructions 205. The system can be programmed in any suitable programming language. Just a few examples are Java, C++, C, and Python.

The processing device 204 of FIG. 2 can execute one or more operations. These operations include accessing resource utilization metric information 208, determining autoscaled values taking into account outlier events, and applying the stored autoscaled values 209 to achieve an appropriate number of instances of an application running in a cloud system. The cloud system 200 includes instances of an application running in cloud network 250. Resource utilization metric information 208 can include selected target values and selected ranges.

Still referring to FIG. 2, memory device 206 can include one memory device or multiple memory devices. The memory device 206 can be non-volatile and may include any type of memory device that retains stored information when powered off. In some examples, at least some of the memory device can include a non-transitory computer-readable medium from which the processing device 204 can read instructions 205. A computer-readable medium can include electronic, optical, magnetic, or other storage devices capable of providing the processing device with computer-readable instructions 205 or other program code. Non-limiting examples of the memory device 206 include electrically erasable and programmable read-only memory (EEPROM), flash memory, or any other type of non-volatile memory. Non-limiting examples of a computer-readable medium include magnetic disk(s), memory chip(s), ROM, random-access memory (RAM), an ASIC, a configured processor, optical storage, or any other medium from which a computer processor can read instructions.

Continuing with FIG. 2, the memory device and the processing device shown may be a portion of a server or similar computer system or multiple computer systems that also include an input/output (I/O) module or modules 210, a random-access memory (RAM, not shown), and a bus or interconnect (not shown) to allow for inter- and intra-device communications. I/O module 210 can include a network interface (not shown), which in turn communicates with cloud network 250. I/O module 210 can also receive input from an administrator related to target values and ranges for utilization metrics. The memory device 206 as shown in this example can also include resource failure criteria 218 for ejection events, although in some of the examples herein such values would be maintained as part of the network proxy function and not the autoscaler function.

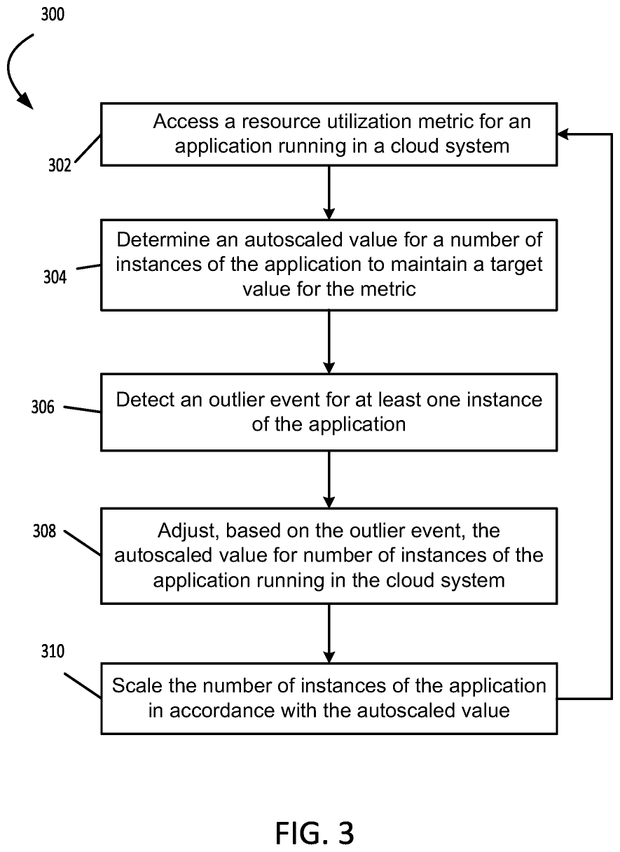

In some examples, a processing device (e.g., processing device 204) can perform one or more of the operations shown in FIG. 3 to provide autoscaling that includes consideration for outlier events according to some aspects of the disclosure. In other examples, the computing device can implement more operations, fewer operations, different operations, or a different order of the operations depicted in FIG. 3. Process 300 of FIG. 3 is described below with reference to components discussed above.

At block 302, processing device 204 accesses a metric for resource utilization for an application running in a cloud system. At block 304, processing device 204 determines an autoscaled value for a number of instances of the application to maintain a target value for the metric. This determination is made based on demand for the application and the strain on computing resources resulting from the demand. At block 306, processing device 204 detects an outlier event for at least one instance of the application. The outlier event is based on a resource failure. At block 308, processing device 204 adjusts the autoscaled value for the number of instances of the application based on the outlier event. For example, if an instance has been ejected from the pool of available instances of the application, the autoscaled value is increased. Conversely, if an instance of the application rejoined the pool, the autoscaled value is decreased. At block 310, the number of instances of the application being used to service requests is scaled in accordance with the autoscaled value.

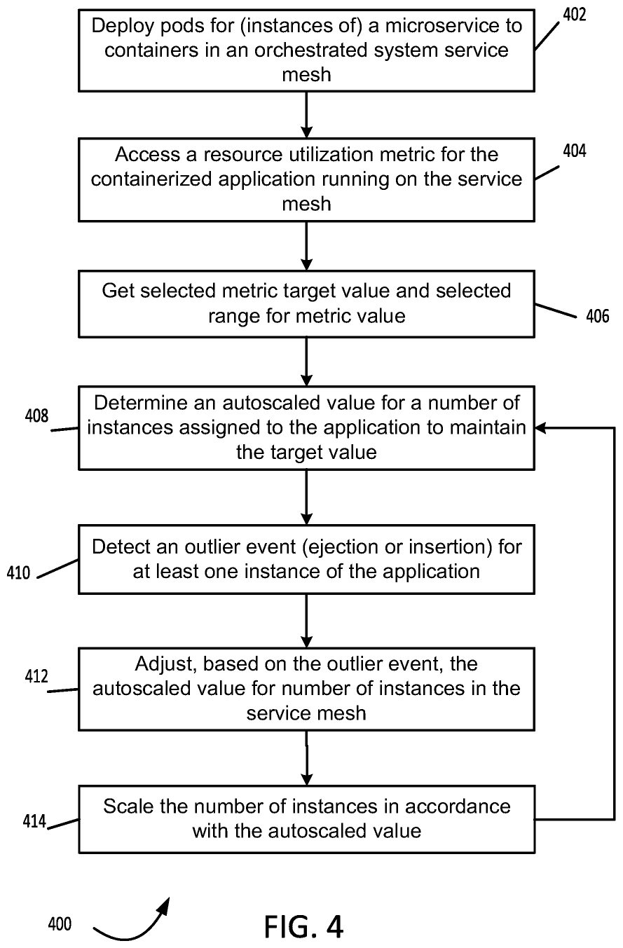

As another example, a computing device can perform the operations of process 400 shown in FIG. 4 to provide autoscaling based on outlier events according to some aspects of the disclosure. Process 400 is an example of a process used with Kubernetes or OpenShift. As such, the containerized application is a microservice running in a service mesh, and instances of the microservice are pods. In other respects, process 400 of FIG. 4 is described below with reference to software and hardware components discussed above.

At block 402 of FIG. 4, the system deploys, under the control of a processing device, pods for a microservice to containers in an orchestrated system service mesh. At block 404, the horizontal autoscaler, run by a processing device such processing device 204, accesses a metric for resource utilization for the microservice running on the service mesh. At block 406, the autoscaler gets the selected metric target value and selected range for the metric value to be used to autoscale the pods. These values may be retrieved from the resource controller. At block 408, autoscaler 102 determines the autoscaled value for the number of pods assigned to the microservice to maintain the target value for the utilization metric selected.

Continuing with FIG. 4, at block 410, autoscaler 102 monitors the service mesh and hence the network proxy and detects an outlier event such as an ejection or insertion directed by the network proxy. The processing device running the horizontal autoscaler can also detect multiple events in a given time window, possibly for multiple pods. At block 412, the autoscaler adjusts the autoscaled value for the number of pods in the service mesh for the microservice, to take into account the outlier event(s). At block 414, the number of pods being used to service requests is scaled in accordance with the determined autoscaled value. The autoscaling process repeats over time as shown, as long at the microservice is running in the system, typically until there is a redeployment or reconfiguration of the service mesh, or the particular application is no longer needed.

In some examples the autoscaler listens to messaging related to pod ejection or insertion events and autoscales based on such events in addition to performing usage-metric based autoscaling. As an alternative, the autoscaler can include an ejection status check as part of executing its metrics equation—checking the number of total pods vs the number of pods that are ejected and not receiving traffic, and considering that number in addition to the usage metrics calculation when scaling the pods.

Unless specifically stated otherwise, it is appreciated that throughout this specification that terms such as “operations,” “processing,” “computing,” and “determining” or the like refer to actions or processes of a computing device, such as one or more computers or a similar electronic computing device or devices that manipulate or transform data represented as physical electronic or magnetic quantities within memories, or other information storage devices, transmission devices, or display devices of the computing platform. The order of the blocks presented in the examples above can be varied—for example, blocks can be re-ordered, combined, or broken into sub-blocks. Certain blocks or processes can be performed in parallel. Ranges, and terms such as “less” or “more,” when referring to numerical comparisons can encompass the concept of equality.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processing device; and
a memory device including instructions that are executable by the processing device for causing the processing device to perform operations comprising:
accessing a resource utilization metric for an application running in a cloud system;
determining an autoscaled value for a number of instances of the application running in the cloud system in order to maintain a target value for the resource utilization metric;
detecting an outlier event corresponding to a resource failure for an instance of the application;
adjusting, based on the outlier event, the autoscaled value for the number of instances of the application running in the cloud system; and
scaling the number of instances on the application running in the cloud system in accordance with the autoscaled value.

2. The system of claim 1, wherein the target value of the resource utilization metric is determined so as to maintain the resource utilization metric within a preselected range of the target value.

3. The system of claim 1 wherein the outlier event comprises an ejection out of or an insertion into a pool of instances of the application.

4. The system of claim 3 wherein the cloud system is configured to perform the ejection based on at least one of a failure rate, a number of consecutive failures, or a percentage of failed operations of the instance, and wherein cloud system is configured to perform the insertion after a specified amount of time has passed from an ejection.

5. The system of claim 1 further comprising a resource controller configured to provide a service mesh that interconnects the instances of the application.

6. The system of claim 4 further comprising a network proxy configured to initiate the outlier event.

7. The system of claim 6 further comprising a horizontal autoscaler to determine the autoscaled value and adjust the autoscaled value in response to the network proxy initiating the outlier event.

8. A method comprising:
accessing, by a processing device, a resource utilization metric for an application running in a cloud system;
determining, by the processing device, an autoscaled value for a number of instances of the application running in the cloud system in order to maintain a target value for the resource utilization metric;
detecting, by the processing device, an outlier event corresponding to a resource failure for an instance of the application;
adjusting, by the processing device, based on the outlier event, the autoscaled value for the number of instances of the application running in the cloud system; and
scaling, by the processing device, the number of instances on the application running in the cloud system in accordance with the autoscaled value.

9. The method of claim 8, wherein the target value of the resource utilization metric is determined so as to maintain the resource utilization metric within a preselected range of the target value.

10. The method of claim 8 wherein the outlier event comprises an ejection out of or an insertion into a pool of instances of the application.

11. The method of claim 10 wherein the cloud system is configured to perform the ejection based on at least one of a failure rate, a number of consecutive failures, or a percentage of failed operations of the instance, and wherein cloud system is configured to perform the insertion after a specified amount of time has passed from an ejection.

12. The method of claim 11 wherein detecting the outlier event comprises monitoring a network proxy.

13. The method of claim 12 wherein adjusting the autoscaled value comprises using a horizontal autoscaler to determine the autoscaled value and to adjust the autoscaled value in response to the network proxy initiating the outlier event.

14. A non-transitory computer-readable medium comprising program code that is executable by a processing device for causing the processing device to:
access a resource utilization metric for an application running in a cloud system;
determine an autoscaled value for a number of instances of the application running in the cloud system in order to maintain a target value for the resource utilization metric;
detect an outlier event corresponding to a resource failure for an instance of the application;
adjust, based on the outlier event, the autoscaled value for the number of instances of the application running in the cloud system; and
scale the number of instances on the application running in the cloud system in accordance with the autoscaled value.

15. The non-transitory computer-readable medium of claim 14, wherein the target value of the metric is maintained by keeping the resource utilization metric within a preselected range of the target value of the metric.

16. The non-transitory computer-readable medium of claim 14 wherein the outlier event comprises an ejection out of or an insertion into a pool of instances of the application.

17. The non-transitory computer-readable medium of claim 16 the resource failure for the ejection comprises at least one of a failure rate, a number of consecutive failures, or a percentage of failed operations of the instance and an insertion occurs a specified amount of time after an ejection.

18. The non-transitory computer-readable medium of claim 14 wherein the program code that is executable by the processing device causes the processing device to control deployment of the instances of the application in a service mesh.

19. The non-transitory computer-readable medium of claim 17 wherein the program code that is executable by the processing device causes the processing device to use a network proxy configured to detect the outlier event by monitoring the service mesh.

20. The non-transitory computer-readable medium of claim 19 wherein the program code that is executable by the processing device causes the processing device to use a horizontal autoscaler to determine the autoscaled value and adjust the autoscaled value in response to the network proxy initiating the outlier event.
